(19) United States
(12) Patent Application Publication
(10) Pub. No.: US 2011/0102470 A1
(43) Pub. Date: May 5, 2011

(54) PORTABLE COMPUTER WITH IMPROVED SCROLL AND METHOD OF CONTROLLING THE SAME

(75) Inventor: Seung-hwa LEE, Gyeonggi-do (KR)

(73) Assignee: SAMSUNG ELECTRONICS CO., LTD., Gyeonggi-Do (KR)

(21) Appl. No.: 12/858,591

(22) Filed: Aug. 18, 2010

(30) Foreign Application Priority Data
Nov. 3, 2009 (KR) 10-2009-0105586

(51) Int. Cl. G06F 3/03; G06F 1/16; G09G 5/00

(52) U.S. Cl. 345/684; 361/679.26; 361/679.1; 345/184

(57) ABSTRACT

A portable computer with an improved scrolling mechanism preferably includes: a display panel through which an image is displayed; an image processing unit configured to process an image displayed through the display panel; a casing configured to accommodate the image processing unit; a manipulation knob which is slidably arranged on the casing; a sensing unit configured to sense a movement of the manipulation knob; and a controller configured to control the image processing unit such that a screen displayed through the display panel is moved according to the movement of the manipulation knob, sensed by the sensing unit. With this configuration, the portable computer permits intuitive movement of a screen displayed through a display panel with ease and precision.

### CLAIM OF PRIORITY

This application claims priority from Korean Patent Application No. 10-2009-0105586, filed on Nov. 3, 2009 in the Korean Intellectual Property Office, the disclosure of which is incorporated herein by reference in its entirety.

### BACKGROUND OF THE INVENTION

1. Field of the Invention

The present invention relates to a portable computer and a method of controlling the same. More particularly, the present invention relates to a portable computer and a method for moving (i.e. scrolling) a screen displayed through a display panel.

2. Description of the Related Art

A portable computer typically includes a display panel through which an image is displayed; an image processing unit which processes an image displayed through the display panel; a display casing which accommodates the display panel; and a main body casing which is rotatably coupled with the display casing and accommodates the image processing unit.

Provided on an upper plate surface of the main body casing are a keyboard for inputting alpha-numeric characters and a touch pad for moving a pointer. The touch pad includes a pointer moving unit which moves a pointer on a screen displayed through the display panel; and a scroll unit which is adjacently provided to move the screen displayed through the display panel vertically.

Since, however, such a conventional scroll unit of the portable computer is embodied as a touch sensing unit, it is difficult to intuitively control the upward and downward movement of the screen with ease and precision.

Further, the pointer moving unit and the scroll unit are adjacently provided from each other to control the movement of the pointer and the vertical movement of the screen with one hand. Accordingly, it is also difficult to quickly control the screen.

### SUMMARY OF THE INVENTION

Accordingly, one or more exemplary embodiments of the present invention provide a portable computer for intuitively moving (scrolling) a screen displayed through a display panel with ease and precision.

Another exemplary embodiment of the present invention is to provide a method for controlling a portable computer of intuitively moving a screen displayed through a display panel with ease and precision.

The foregoing and/or other aspects may be achieved by providing a portable computer comprising: a display panel through which an image is displayed; an image processing unit configured to process an image displayed through the display panel; a casing configured to accommodate the image processing unit; a manipulation knob which is slidably arranged on the casing; a sensing unit configured to sense a movement of the manipulation knob; and a controller configured to control the image processing unit such that a screen displayed through the display panel is moved according to the movement of the manipulation knob, sensed by the sensing unit.

### BRIEF DESCRIPTION OF THE DRAWINGS

The above and/or other exemplary aspects of the present invention will become apparent and more readily appreciated by a person of ordinary skill in the art from the following description of the exemplary embodiments, taken in conjunction with the accompanying drawings, in which:

FIG. 1 is a perspective view showing an outer appearance of a portable computer in accordance with a first exemplary embodiment of the present invention;

FIG. 2 is an exploded perspective view showing a peripheral structure of a manipulation knob of the portable computer in accordance with the first exemplary embodiment;

FIG. 3A is a sectional view showing that the manipulation knob is placed at an intermediate position in the portable computer in accordance with the first exemplary embodiment, and FIG. 3B shows a corresponding screen displayed through a display panel;

FIG. 4A is a sectional view showing that the manipulation knob is placed at an upward position in the portable computer in accordance with the first exemplary embodiment, and FIG. 4B shows a corresponding screen displayed through a display panel;

FIG. 5A is a sectional view showing that the manipulation knob is placed at a downward position in the portable computer in accordance with the first exemplary embodiment, and FIG. 5B shows a corresponding screen displayed through a display panel;

FIGS. 6A and 6B are sectional views showing portable computers in accordance with modifications of the first exemplary embodiment;

FIG. 7 is a block diagram showing the portable computer in accordance with the first exemplary embodiment;

FIG. 8 is a perspective view showing an outer appearance of a portable computer in accordance with a second exemplary embodiment;

FIG. 9 is a perspective view showing an outer appearance of a portable computer in accordance with a third exemplary embodiment; and

FIG. 10 is a perspective view showing an outer appearance of a portable computer in accordance with a fourth exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known structures and functions may be omitted for clarity, when their inclusion would obscure appreciate of the present claimed invention by the person of ordinary skill in the art. Like reference numerals refer to like elements throughout the disclosure.

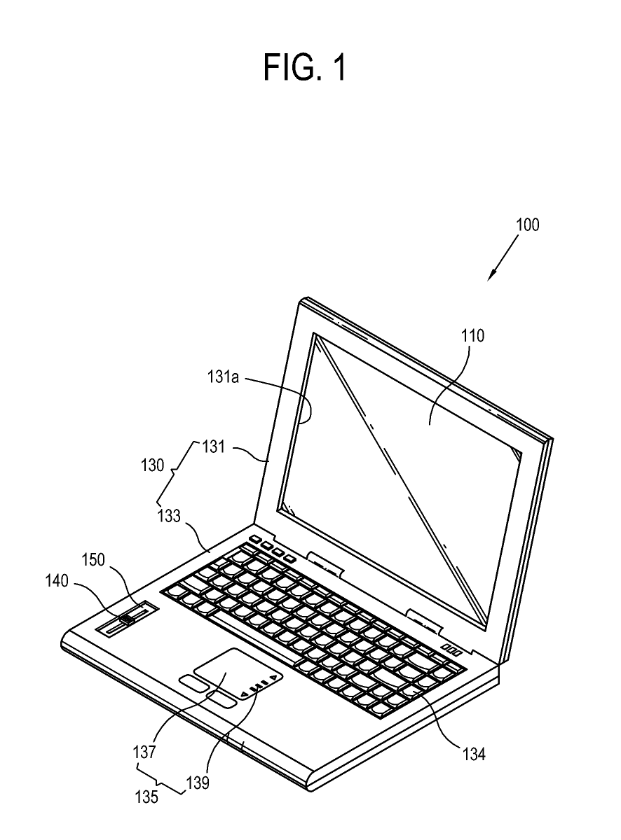

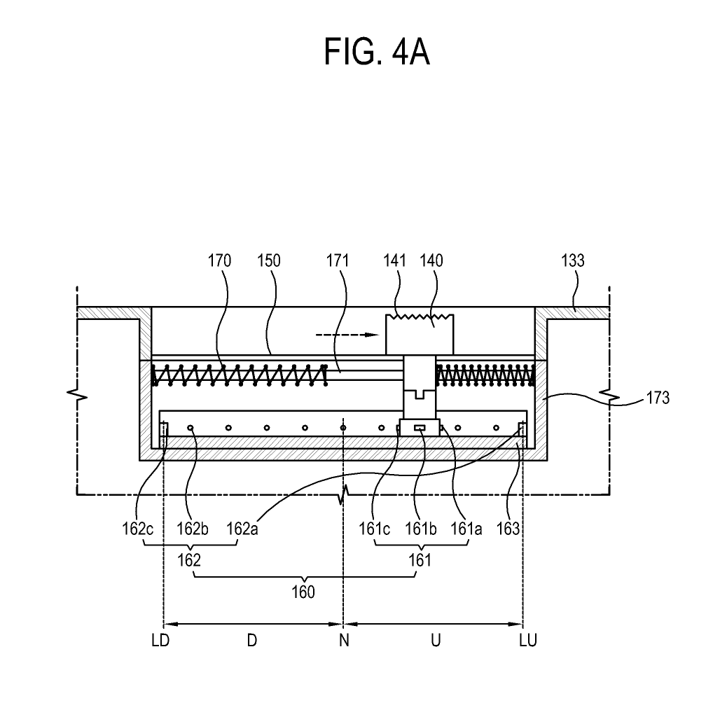

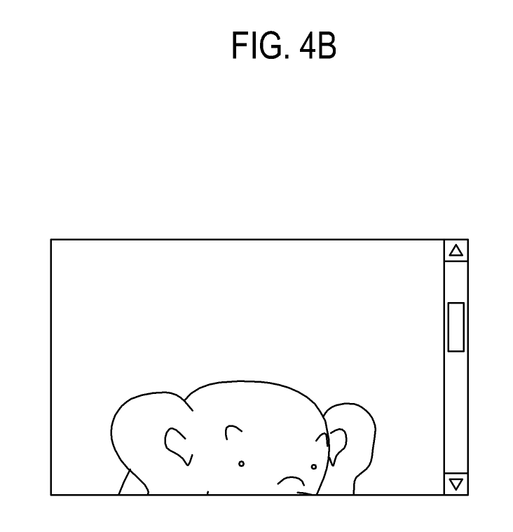

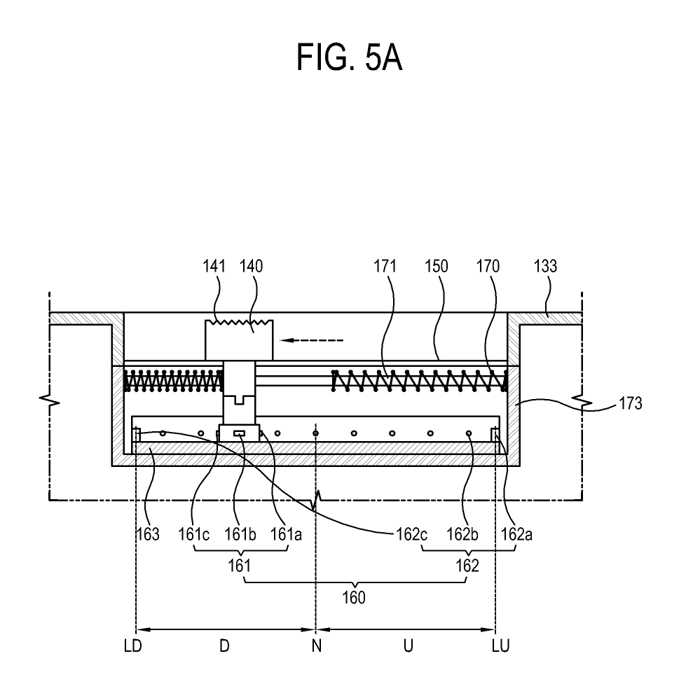

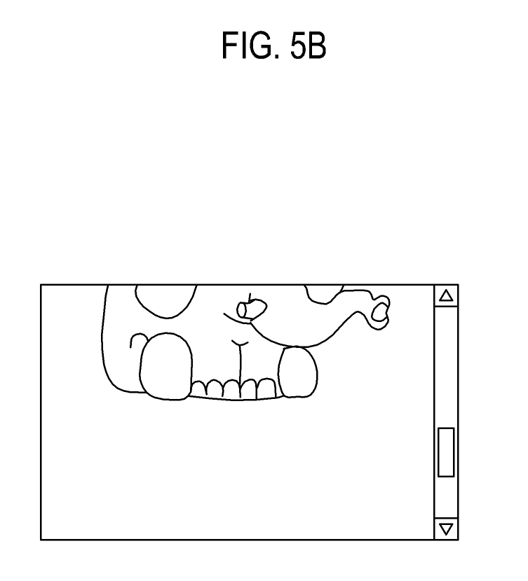

First, a portable computer 100 in accordance with a first exemplary embodiment will now be described in detail with reference to FIGS. 1 to 7.

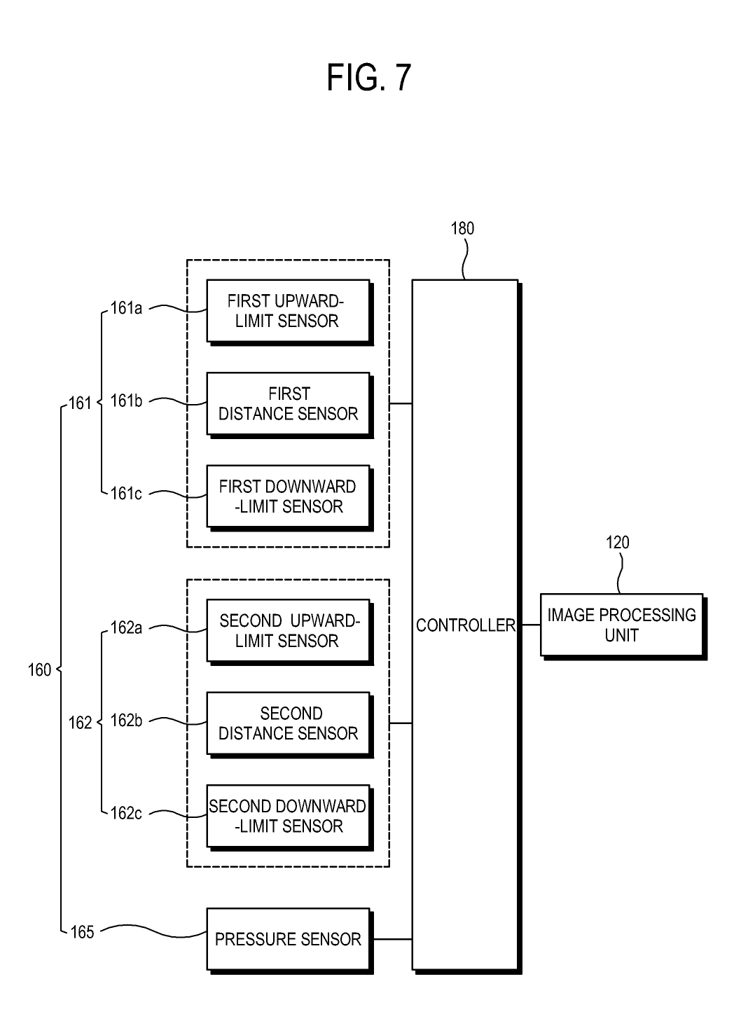

The portable computer 100 of the first exemplary embodiment preferably includes a display panel 110 through which an image is displayed; an image processing unit 120 (FIG. 7) which processes an image displayed through the display panel 110; a casing 130 which accommodates the image processing unit 120 therein; a manipulation knob 140 which is slidably arranged in the casing 130; a sensing unit 160 which senses the movement of the manipulation knob 140; and a controller 180 which controls the image processing unit 120 such that a screen displayed through the display panel 110 is moved according to the movement of the manipulation knob 140 sensed by the sensing unit 160.

The display panel 110 may display an image processed by the image processing unit 120. The display panel 110 may be embodied as a liquid crystal display (LCD) or a plasma display panel (PDP), or any other type of thin-film technology and thin screen display. The display panel 110 is preferably mounted in the casing 130.

The image processing unit 120 preferably processes an image displayed through the display panel 110. The image processing unit 120 may be accommodated in the casing 130.

The casing 130 may include a display casing 131 which accommodates the display panel 110; and a main body casing 133 which is rotatably coupled with the display casing 131 and accommodates the image processing unit 120.

In the present exemplary embodiment, the casing 130 may be embodied as two parts, i.e., the display casing 131 and the main body casing 133 as described above and shown therein. The casing 130, however, may be embodied as one single part to accommodate therein the image processing unit 120 and the display panel 110, for example, as a table computer or similar device.

The display casing 131 may be rotated in a forward and a backward direction with respect to the main body casing 133. The display panel 110 may be accommodated in the display casing 131. An opening 131a is formed in one (i.e., a front surface) of opposing plate surfaces of the display casing 133, facing the main body casing 133 when being into contact therewith. The opening 131a may expose a display area of the display panel 110 to the outside.

The main body casing 133 may accommodate therein various components of the image processing unit 120, such as a main board (not shown), a central processing unit (CPU) (not shown), and a memory (not shown). A keyboard 134 and a touch pad 135 may respectively be arranged at a front and a back portion of an upper plate surface of the main body casing 133. The keyboard 134 may be used for inputting alpha-numeric characters.

The touch pad 135 may include a pointer moving unit 137 which moves a pointer on a screen displayed through the display panel 110 in accordance with corresponding movement on the touch pad, although of course not to scale. The touch pad 135 may further include a scroll unit 139 which is adjacently provided from the pointer moving unit 137 to vertical adjust the screen displayed through the display panel 110. Here, the pointer moving unit 137 and the scroll unit 139 may be adjacently provided from each other as described above. The scroll unit 139 may be provided at a right edge portion of the pointer moving unit 137 in a forward and a backward direction.

The touch pad 135 may be arranged at a central or a right side portion of the upper plate surface of the main body casing 133.

The manipulation knob 140 may movably be provided on the casing 130. The manipulation knob 140 reciprocate between an upward position U for upwardly moving a screen displayed through the display panel 110 and a downward position D for downwardly moving the screen displayed through the display panel 110.

Specifically, the manipulation knob 140 may be arranged on the display casing 131 or the main body casing 133. In the present exemplary embodiment, the manipulation knob 140 may be arranged on an upper surface of the main body casing 133. The manipulation knob 140 may slide in a forwarding direction to reach the upward position U or in the backward direction to reach the downward position D. Further, the manipulation knob 140 may be brought to an intermediate position N between the upward and the downward position U and D, the intermediate position for stopping the movement of the screen displayed through the display panel 110.

The manipulation knob 140 also may preferably be arranged separately from the touch pad 135. The manipulation knob 140 may be arranged at a more left portion than that of the touch pad 135, so that a user moves the pointer by manipulating the touch pad 135 with his/her right hand while moving the screen by manipulating the manipulation knob 140 with his/her left hand. Accordingly, the user may more quickly control the screen than in the conventional method. The manipulation knob 140 may alternatively be arranged at a more right portion than that of the touch pad 135.

In the meantime, formed on a plate surface of the casing 130 may be a guide portion 150 which is recessed in a moving direction of the manipulation knob 140 to guide the movement of the manipulation knob 140. In the present exemplary embodiment, since the manipulation knob 140 is arranged on the upper plate surface of the main body casing 133, the guide portion 150 is formed by being recessed in the upper plate surface of the main body casing 133.

The guide portion 150 may preferably be recessed by a depth that is similar to or greater than a height of the manipulation knob 140. In other words, the guide portion 150 may be recessed to accommodate the manipulation knob 140 by a depth allowing the manipulation knob 140 not to protrude from the upper plate surface of the main body casing 133. Accordingly, when the display casing 131 is brought into contact with the main body casing 133, the display panel 110 or the display casing 131 may not be interrupted by the manipulation knob 140.

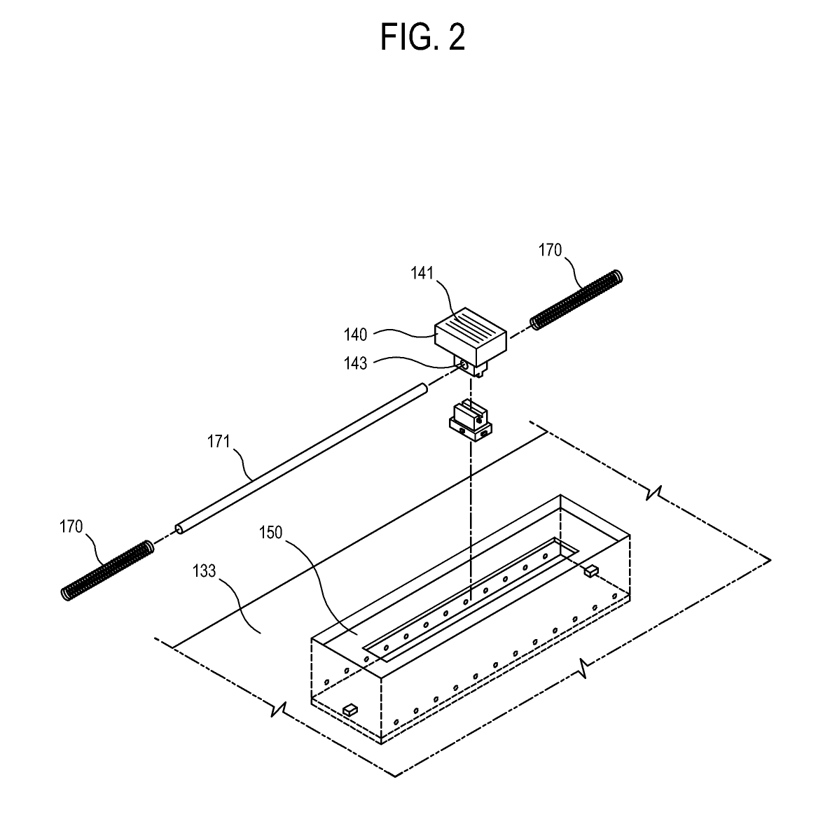

With continued reference to FIG. 2, an antiskid protrusion 141 may be formed on a plate surface of the guide portion 150, the plate surface being exposed to the outside, in a horizontal direction of the moving direction of the manipulation knob 140. The antiskid protrusion 141 may serve to prevent a user's hand to skid when manipulating the manipulation knob 140. A plurality of antiskid protrusions 141 may be separately provided from each other. When no antiskid protrusion 141 is provided, a non-slip member (not shown) may be coated or attached on the plate surface of the guide portion 150, being exposed to the outside.

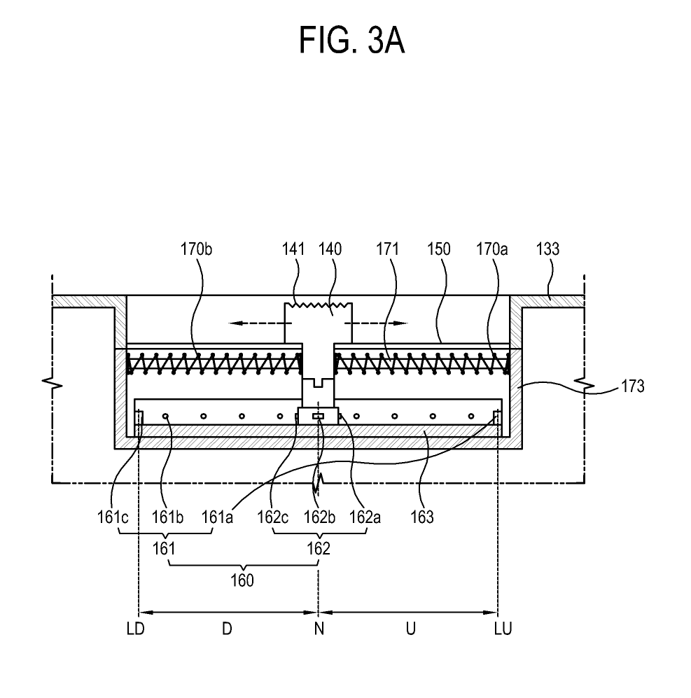

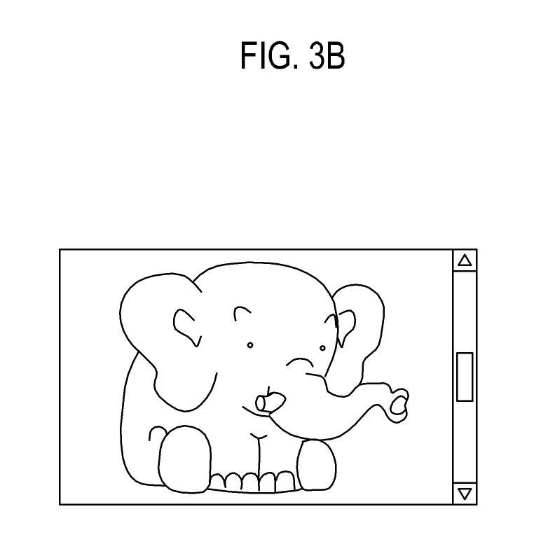

As shown in FIG. 3A, the sensing unit 160 may sense the movement of the manipulation knob 140. The sensing unit 160 may sense the movement of the manipulation knob 140 by using various methods. For example, the sensing unit 160 may include at least one of various sensors such as a proximity sensor, a photo sensor, an infrared sensor, an ultrasonic sensor, a touch sensor, and a pressure sensor, just to name a few possibilities, to sense the movement of the manipulation knob 140. In other words, the sensing unit 160 may serve to sense at least one of: (1) a position of the manipulation knob 140, whether or not the manipulation knob 140 is moved, (2) a moving time thereof, (3) a position-maintaining time thereof after movement, (4) a moving speed thereof, (5) a moving pressure thereof, and (6) a moving distance thereof. The sensing unit 160 may sense the movement of the manipulation knob 140 and transfer sensed position information to the controller 180.

The controller 180 may control the image processing unit 120 such that a screen displayed through the display panel 110 is moved according to the movement of the manipulation knob 140, and is sensed by the sensing unit 160.

The controller 180 may control the image processing unit 120 to increase a moving speed or a moving distance of the screen displayed through the display panel 110 in proportion to the sensed result of at least one of: (1) a position of the manipulation knob 140, (2) whether or not the manipulation knob 140 is moved, (3) a moving time thereof, (4) a position-maintaining time thereof after movement, (5) a moving speed thereof, (6) a moving pressure thereof, and (7) a moving distance thereof.

In the present exemplary embodiment such as shown in FIG. 3A, the sensing unit 160 may include a printed circuit board (PCB) 163 which is accommodated in the main body casing 133 and performs a communication with the controller 180; a first sensing unit 161 which is coupled to the PCB 163; and a second sensing unit 162 which is moved along with the manipulation knob 140 by being coupled to the manipulation knob 140.

In the present exemplary embodiment, the first sensing unit 161 may sense a moving distance and a position of the second sensing unit 162. Specifically, the first sensing unit 161 may sense a moving distance and a position of the second sensing unit 162 that is moved in a moving direction of the manipulation knob 140.

The first sensing unit 161 may also sense the moving distance and the position of the second sensing unit 162. The first sensing unit 161 may divide the position of the second sensing unit 162 into an upward-limiting position LU, an upward position U, an intermediate position N, a downward position D, and a downward-limiting position LD to sense the movement of the manipulation knob 140.

The upward-limiting position LU, which is a position of the manipulation knob 140 when the second sensing unit 162 is moved to a most front portion, may be used such that the controller 180 continuously moves the screen upwardly for display through the display panel 110. The first and the second sensing unit 161 and 162 may include a first and a second upward-limiting sensor 161a and 162a, respectively. At the upward-limit position LU, the first upward-limiting sensor 161a may be brought into contact with the second upward-limiting sensor 162a.

The upward position U, which is a position of the manipulation knob 140 when the second sensing unit is moved to a portion between the upward-limiting position LU and the intermediate position N, may be used such that the controller 180 upwardly moves the screen displayed through the display panel 110 in proportion to a distance by which the manipulation knob 140 is forwardly moved from the intermediate position N. The first and the second sensing units 161, 162 may include first and second distance sensors 161b, 162b, respectively. Here, the first distance sensor 161b may sense a moving distance and a position of the second distance sensor 162b.

The intermediate position N, which is a position of the manipulation knob 140 when the second sensing unit 162 is moved to an intermediate portion in a lengthwise direction of the guide portion 150, may be used such that the controller 180 does not move the screen displayed through the display panel 110. Here, the intermediate position N may be set as an intermediate section having a predetermined range in the lengthwise direction of the guide portion 150 instead of an intermediate portion. In other words, when the second sensing unit 162 is minutely upwardly or downwardly moved in the intermediate section, the first sensing unit 161 may sense that the second sensing unit 162 is placed at the intermediate position N.

The downward-limiting position LD, which is a position of the manipulation knob 140 when the second sensing unit 162 is moved to a most back portion, may be used such that the controller 180 continuously downwardly moves the screen displayed through the display panel 110. The first and the second sensing unit 161 and 162 may include a first and a second downward-limiting sensor 161c and 162c, respectively. At the downward-limiting position LD, the first downward-limiting sensor 161c may be brought into contact with the second downward-limiting sensor 162c.

The downward position D, which is a position of the manipulation knob 140 when the second sensing unit is moved to a portion between the downward-limiting position LD and the intermediate position N, may be used such that the controller 180 downwardly moves the screen displayed through the display panel 110 in proportion to a distance by which the manipulation knob 140 is backwardly moved from the intermediate position N. Here, the first distance sensor 161b may sense a moving distance and a position of the second distance sensor 162b.

Meanwhile, the portable computer 100 of the present exemplary embodiment may further include an elastic member 170 for elastically pressurizing the manipulation knob 140 such that the manipulation knob 140 is maintained at the intermediate position N. A pair of elastic members 170a, 170b may be provided, one 170 and the other elastic member 170b of which is arranged at a front and a back portion, respectively, of the manipulation knob 140. Accordingly, when there is no manipulation from a user, the manipulation knob 140 may be continuously maintained at the intermediate position N.

In the present exemplary embodiment, the elastic members 170a, 170b, may be embodied as coil springs. A rod-shaped elastic member guide 171 may be provided therein in a lengthwise direction.

Electric member supports 173 may respectively be provided at a front and a back area of the guide portion 150 to support opposite ends of the elastic guide 171. Here, a through-hole 143 may be formed in the manipulation knob 140 to allow the elastic member guide to pass therethrough. The manipulation knob 140 may be moved between the upward and the downward-limit position LU and LD by the elastic member guide 171 accommodated through the through hole 143.

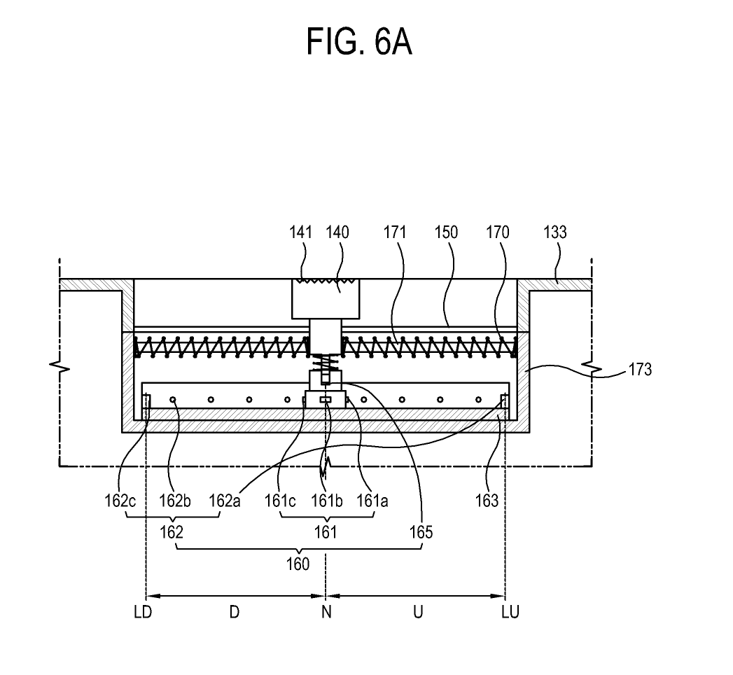

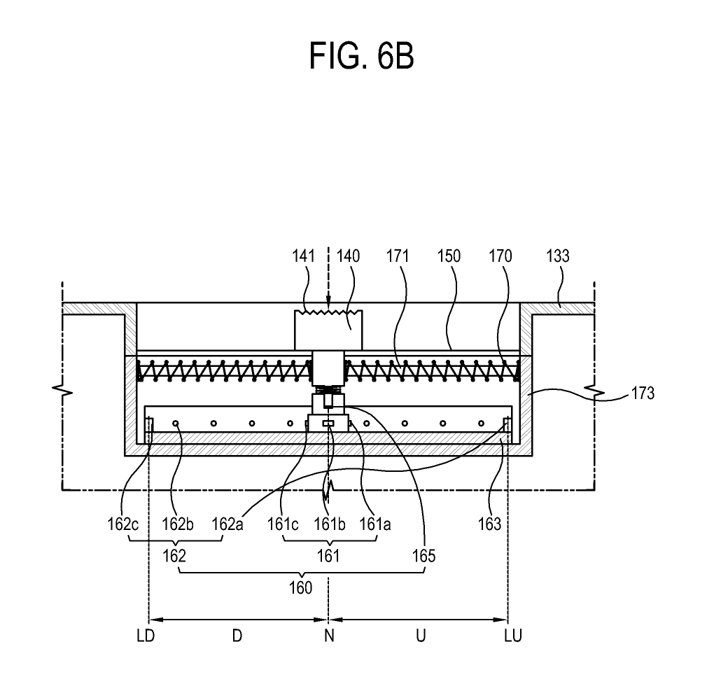

In accordance with modifications of the first exemplary embodiment, as FIGS. 6A and 6B, the sensing unit 160 may sense the movement of the manipulation knob 140 when the manipulation knob 140 is moved by being pressurized in a horizontal direction of the upper plate surface of the main body casing 133, i.e., a height direction of the manipulation knob 140. The second sensing unit 162 may include a pressure sensor 165 which senses a vertical pressuring force of the manipulation knob 140. The pressure sensor 165 may sense an upward and a downward movement of the manipulation knob 140. The controller 180 may control the sensing unit 160 to sense a front and a back directional position of the manipulation knob 140 only when the manipulation knob 140 is downwardly moved. Although, as the sensing unit 160 is provided to sense the front and the back directional position of the manipulation knob 140 only when the manipulation knob 140 is downwardly moved, the controller 180 may control the image processing unit 120 not to move the screen displayed through the display panel 110.

In the meantime, a locking structure (not shown) may be applied thereto to forwardly or backwardly move the manipulation unit 140 only when the manipulation knob 140 is downwardly moved in the vertical direction.

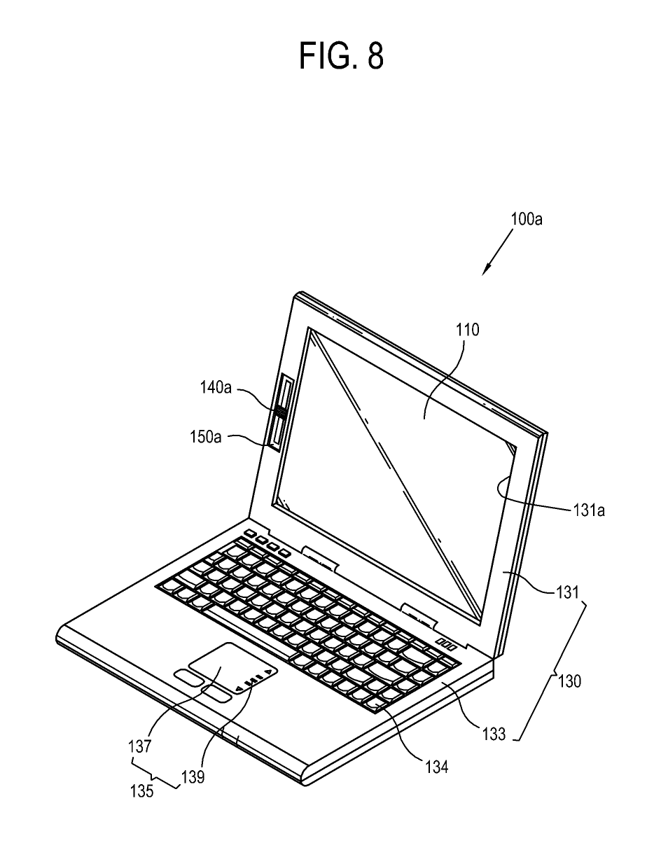

FIG. 8 is a perspective view showing an outer appearance of a portable computer 100a in accordance with a second exemplary embodiment. In the second exemplary embodiment, it is shown that a manipulation knob 140a may be provided at a left edge area of the display casing 131.

Even though the manipulation knob 140a of the present exemplary embodiment is provided at a left edge portion of a front surface of the display casing 131 as described in FIG. 8, the manipulation knob 140a may alternatively be provided at a right edge portion of the front surface thereof. Further, alternatively, the manipulation knob 140a may be provided at a portion of a left or a right wall of the display casing 131. For example, there can be left-handed and right-handed versions of the invention, wherein one prefers to move the manipulation knob with one particular hand and use the pointing pad with another particular hand, so the manipulation knob is arranged on the left side or right side, accordingly.

In the present exemplary embodiment, the manipulation knob 140a may be reciprocated between the upward position U for upwardly moving the screen displayed through the display panel 110, and the downward position for downwardly moving the screen displayed through the display panel 110 by upwardly and downwardly sliding in a plate-surface direction of the display panel 110. Here, a guide portion 150a may be formed at a left side portion of the front surface of the display casing 131 in the plate-surface direction and an upward and downward direction of the display panel 110.

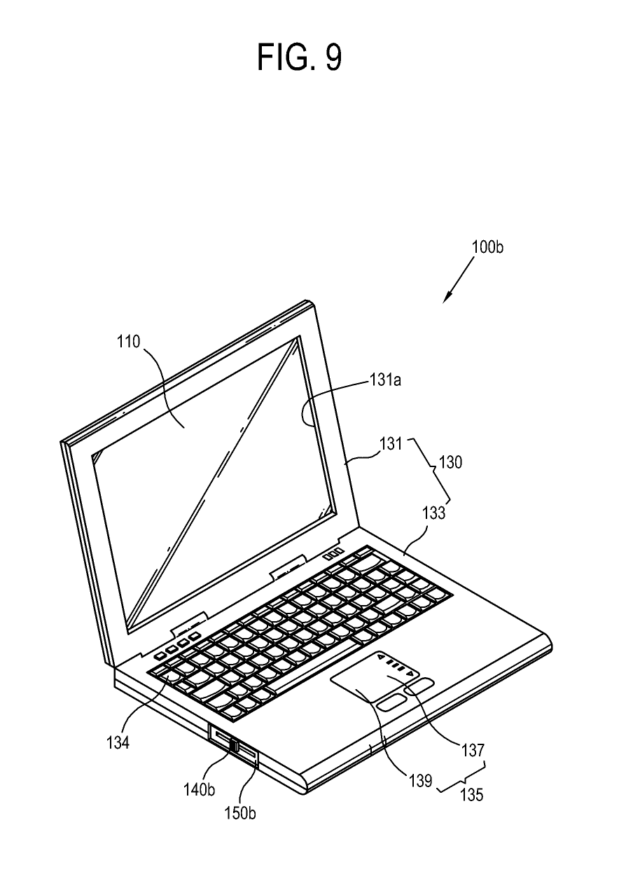

FIG. 9 is a perspective view showing an outer appearance of a portable computer 100b in accordance with a third exemplary embodiment. In the third exemplary embodiment, a manipulation knob 140b may be provided on a left sidewall surface of the main body casing 133.

Even though the manipulation knob 140b of the present embodiment is provided on the left sidewall surface of the main body casing 133 as described in FIG. 9, the manipulation knob 140b may alternatively be provided on a right sidewall surface thereof.

In the present exemplary embodiment, the manipulation knob 140b may be reciprocated between the upward position U for upwardly moving the screen displayed through the display panel 110 and the downward position for downwardly moving the screen displayed through the display panel 110 by forwardly and downwardly sliding. Here, a guide portion 150b may be formed on the left sidewall surface of the display casing 131 in a forward and backward direction thereof. Alternatively, the guide portion 150b may be formed on the left sidewall surface of the display casing 131 in an upward and downward direction thereof.

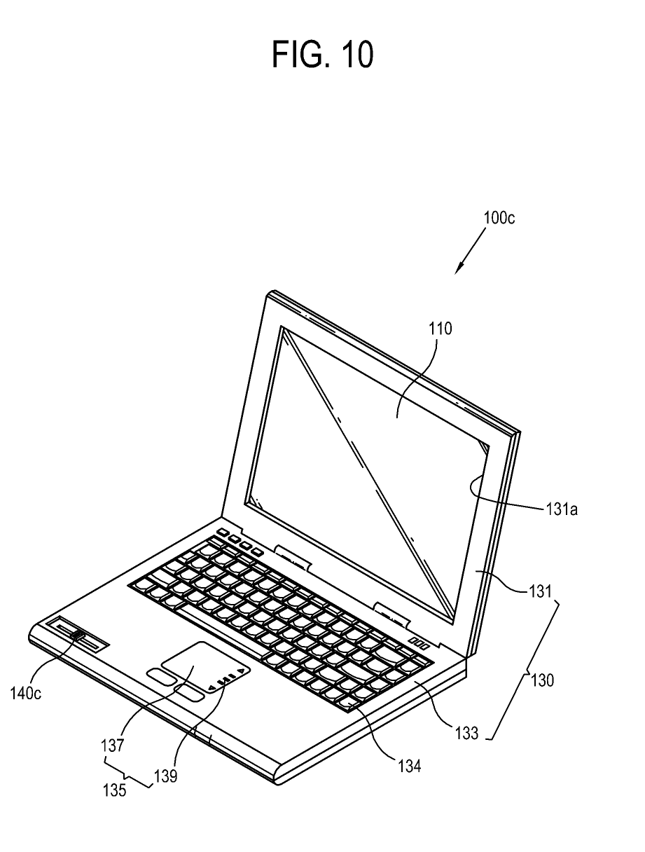

In accordance with the above-mentioned exemplary embodiments, a screen displayed through the display panel 110 may upwardly and downwardly scrolled according to the movement of the manipulation knob 140. However, when a manipulation knob 140c is movable left and right in a portable computer 100c in accordance with a fourth exemplary embodiment as shown in FIG. 10, a screen displayed through the display panel 110 may be scrolled left and right according to a left or a right movement of the manipulation knob 140c.

In accordance with the aforementioned exemplary embodiments, the manipulation knob 140, 140a, 140b, or 140c is moved by sliding with respect to the casing 130. However, the manipulation knob 140, 140a, 140b, or 140c may be rotated with respect to the casing 130.

Hereinafter, a method of controlling the portable computer 100 in accordance with the first exemplary embodiment will be described in detail.

First, a user may move a pointer on a screen displayed through the display panel 110 by using a touch pad with his/her right hand. At this time, the user may scroll the screen displayed through the display panel 110 by manipulating the manipulation knob 140 with his/her left hand.

Then, if the user downwardly starts to apply pressure to the manipulation knob 140 that is placed at the intermediate position N, the pressure sensor 165 (FIG. 6A) may be operated and the sensing unit 160 may start to sense a position of the manipulation knob 140. If the user forwardly moves the manipulation knob 140, the manipulation knob 140 may be moved to the upward position U. Here, the sensing unit 130 may sense an upwardly-moved position of the manipulation knob 140 and transfer a sensed result to the controller 180. The controller 180 may control the image processing unit 120 to upwardly move the screen displayed through the display panel 110 in proportion to a distance by which the manipulation knob 140 is forwardly moved from the intermediate position N.

If the user additionally moves the manipulation knob 140 forward and the sensing unit 160 senses the upward-limit position LU of the manipulation knob 140, the controller 180 may control the image processing unit 120 to continuously upwardly move the screen displayed through the display panel 110. Here, the controller 180 may control the image processing unit 120 to move the screen displayed upwardly through the display panel 110 at a regular speed.

On the other hand, if the user releases a pressure on the manipulation knob 140 in a moving direction thereof, the manipulation knob 140 may return to the intermediate position N by an elastic force of the elastic member 170. If the user releases the pressure in a vertical direction of the manipulation knob 140, the pressure sensor 165 may elastically be restored and increased to upwardly move the manipulation knob 140.

If the user moves the manipulation knob 140 backward to the downward position D or the downward-limiting position LD, the controller 180 may control the image processing unit 120 to downwardly scroll the screen displayed through the display panel 110.

In accordance with the above exemplary embodiments, it is possible to provide a portable computer and a method of controlling the same, capable of intuitively moving a screen displayed through a display panel with ease and precision.

The above-described methods according to the present invention can be realized in hardware or as software or computer code that can be stored in a recording medium such as a CD ROM, an RAM, a floppy disk, a hard disk, or a magneto-optical disk or downloaded over a network for storage on a medium such as one of the aforementioned, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although a few exemplary embodiments have been shown and described, it will be appreciated by those skilled in the art that various changes may be made in these exemplary embodiments without departing from the principles and spirit of the invention, the scope of which is defined in the appended claims and their equivalents. For example, the manipulation knob can be arranged in a mobile terminal, such as a telephone, PDA, etc., with a touch screen or a regular display screen to obtain more accurate control over scrolling movement of an image.

What is claimed is:

1. A portable computer comprising:
a display panel through which an image is displayed;
an image processing unit configured to process an image displayed by the display panel;
a casing configured to house the image processing unit;
a manipulation knob which is movably provided on the casing;
a sensing unit configured to sense a movement of the manipulation knob; and
a controller configured to control the image processing unit such that a screen displayed through the display panel is scrolled according to movement of the manipulation knob, as sensed by the sensing unit.

2. The portable computer of claim 1, wherein the casing comprises a display casing that houses at least a portion of the display panel and a main body casing which is rotatably coupled with the display casing and houses the image processing unit, and
wherein the manipulation knob is arranged on at least one of the display casing and the main body casing.

3. The portable computer of claim 2, wherein the manipulation knob is provided on an upper plate surface of the main body casing, and
the manipulation knob reciprocates between an upward position for upwardly scrolling the screen displayed through the display panel and a downward position for downwardly scrolling the screen displayed through the display panel by sliding or rotating the manipulation knob forwardly and downwardly.

4. The portable computer of claim 2, wherein the manipulation knob is arranged on a sidewall surface of the main body casing, and
the manipulation knob reciprocates between an upward position for upwardly scrolling the screen displayed through the display panel and a downward position for downwardly scrolling the screen displayed through the display panel by upwardly and downwardly sliding or rotating the manipulation knob.

5. The portable computer of claim 2, wherein the manipulation knob is arranged on an edge area of the main body casing, and
the manipulation knob reciprocates between an upward position for upwardly scrolling the screen displayed through the display panel and a downward position for downwardly scrolling the screen displayed through the display panel by upwardly and downwardly sliding or rotating the manipulation knob in a plate-surface direction of the display panel.

6. The portable computer of claim 1, wherein a guide portion is recessed on a plate surface of the casing in a moving direction of the manipulation knob to guide the movement of the manipulation knob.

7. The portable computer of claim 6, wherein the manipulation knob does not extrude from the plate surface of the casing.

8. The portable computer of claim 3, further comprising: an elastic member configured to bias the manipulation knob such that the manipulation knob is maintained at an intermediate position.

9. The portable computer of claim 1, wherein the sensing unit comprises at least one of a proximity sensor, a photo sensor, an infrared sensor, an ultrasonic sensor, a touch sensor, and a pressure sensor.

10. The portable computer of claim 1, wherein the sensing unit senses the movement of the manipulation knob when the manipulation knob is moved from being biased in a height direction of the manipulation knob as a horizontal direction of the upper plate surface of the casing.

11. The portable computer of claim 2, wherein a keyboard and a touch pad for moving a pointer are provided on the upper plate surface of the main body casing, and
the manipulation knob is separately arranged from the touch pad.

12. The portable computer of claim 11, wherein the sensing unit senses at least one of a position of the manipulation knob, whether or not the manipulation knob is moved, a moving time thereof, a position-maintaining time thereof after movement, a moving speed thereof, a moving pressure thereof, and a moving distance thereof, and
the controller controls the image processing unit to increase a scrolling speed or a scrolling distance of the screen displayed through the display panel in proportion to a sensed result of at least one of a position of the manipulation knob, whether or not the manipulation knob is moved, a moving time thereof, a position-maintaining time thereof after movement, a moving speed thereof, a moving bias pressure thereof, and a moving distance thereof.

13. The portable computer of claim 6, wherein the controller continuously upwardly scrolls the screen displayed through the display panel when the manipulation knob is moved to an upward-limit position as one end of the guide portion through the upward position, and
the controller continuously downwardly scrolls the screen displayed through the display panel when the manipulation knob is moved to a downward-limit position as another end of the guide portion through the downward position.

14. The portable computer of claim 2, wherein the manipulation knob is provided on an upper plate surface of the main body casing, and
the manipulation knob slides or rotates left or right to scroll left or right the screen displayed through the display panel.

15. A mobile terminal comprising: a display panel through which an image is displayed; an image processing unit configured to process an image displayed by the display panel;
a casing configured to house the image processing unit; and
a manipulation knob which is movably provided on the casing.

16. A method of controlling a portable computer including a display panel through which an image is displayed; an image processing unit configured to process an image displayed through the display panel; and a casing configured to house the image processing unit, the method comprising:
sensing a movement of a manipulation knob which is movably provided on the casing; and scrolling a screen displayed through the display panel according to the sensed movement of the manipulation knob.

17. The method of claim 16, wherein the sensing comprises sensing at least one of a position of the manipulation knob, whether or not the manipulation knob is moved, a moving time thereof, a position-maintaining time thereof after movement, a moving speed thereof, a moving pressure thereof, and a moving distance thereof, and
the moving comprises increasing a scrolling speed or a scrolling distance of the screen displayed through the display panel in proportion to a sensed result of at least one of a position of the manipulation knob, whether or not the manipulation knob is moved, a moving time thereof, a position-maintaining time thereof after movement, a moving speed thereof, a moving bias pressure thereof, and a moving distance thereof.

18. The method according to claim 16, wherein the manipulation knob is arranged along at least one of a right side or left side of the casing as a left-handed or right handed version.
